(19) United States
(12) Patent Application Publication
(10) Pub. No.: US 2021/0006412 A1
(43) Pub. Date: Jan. 7, 2021

(54) COMMUNICATIONS SYSTEM AND DEVICES FOR ROUTING DATA

(71) Applicant: QUANTA NETWORKS INC., Brampton (CA)

(72) Inventor: Dan GAHLINGER, Scarborough (CA)

(21) Appl. No.: 16/977,008

(22) PCT Filed: Mar. 4, 2019
(86) PCT No.: PCT/IB2019/051740

§ 371 Date: Aug. 31, 2020

Related U.S. Application Data
(60) Provisional application No. 62/638,507, filed on Mar. 5, 2018.

(51) Int. Cl. H04L 9/32; H04L 29/06; H04W 12/12; H04W 48/16; H04W 8/22; H04W 8/26

(52) U.S. Cl. CPC H04L 9/3247; H04L 63/1416; H04L 63/145; H04L 63/1458; H04L 9/3239; H04L 2209/80; H04W 48/16; H04W 8/22; H04W 8/26; H04L 2209/38; H04W 12/1208

(57) ABSTRACT

A mobile electronic device includes a wireless communications interface to communicate data, memory, and a processor connected to the wireless communications interface and the memory. The processor identifies an address of a destination mobile electronic device to be transmitted a discrete quantum of data from the memory via the wireless communications interface. The address conforms to an address space defined for a plurality of devices including the mobile electronic device and the destination mobile electronic device. The address space includes a network address of a given device of the plurality of devices and a spatial address indicative of a geographic location of the given device. The processor further initiates transmission of the discrete quantum of data to the identified address.

### FIELD

This disclosure relates to computing devices and networks.

### BACKGROUND

Known networking technologies and address spaces are limited. This problem is becoming more pronounced as network-enabled electronic devices proliferate. Further, the mobility of many types of electronic devices has not been adequately taken into account by existing systems. The ever-increasing quantity and mobility of various types of electronic devices poses significant technological challenges to providing secure and efficient communications.

### BRIEF DESCRIPTION OF THE FIGURES

FIG. 1 is a schematic diagram of a communications system.

FIG. 2 is a schematic diagram of a node attempting to associate with another node.

FIG. 3 is a schematic diagram of an isolated node attempting to associate with another node.

FIG. 4 is a schematic diagram of a node detecting a heartbeat signal.

FIG. 5 is a schematic diagram of cluster with a master node.

FIG. 6 is a schematic diagram of a node joining a cluster.

FIG. 7 is a schematic diagram of multiple clusters of nodes.

FIG. 8 is a schematic diagram of conduits among clusters of nodes.

FIG. 9 is a schematic diagram of additional conduits among clusters of nodes.

FIG. 10 is a state diagram of node types/subtypes.

FIG. 11 is a schematic diagram of data communication in the communications system.

FIG. 12 is a block diagram of a mobile electronic device.

### SUMMARY

According to an aspect of the invention, a mobile electronic device includes a wireless communications interface to communicate data, memory, and a processor connected to the wireless communications interface and the memory. The processor is to identify an address of a destination mobile electronic device to be transmitted a discrete quantum of data from the memory via the wireless communications interface. The address conforms to an address space defined for a plurality of devices including the mobile electronic device and the destination mobile electronic device. The address space includes a network address of a given device of the plurality of devices and a spatial address indicative of a geographic location of the given device. The processor is further to initiate transmission of the discrete quantum of data to the identified address.

The mobile electronic device may further include a positioning subsystem to determine a geographic location of the mobile electronic device. The memory may maintain an address of the mobile electronic device including a spatial address corresponding to the geographic location of the mobile electronic device as determined by the positioning subsystem.

The processor may generate a heartbeat signal and to broadcast the heartbeat signal via the wireless communications interface. The heartbeat signal may indicate the address of the mobile electronic device.

The heartbeat signal may further indicate a unique hardware identifier of the mobile electronic device.

The processor may append the address of the mobile electronic device to a routing log included with the discrete quantum of data.

The memory may maintain an indication of node type for the mobile electronic device within a network associated with the address space. The node type may be selected from a plurality of node types.

The plurality of node types may include an isolated node type. When the mobile electronic device is the isolated node type, the processor may broadcast a heartbeat signal indicating the address of the mobile electronic device and may listen via the wireless communications interface for heartbeat signals broadcasted by other devices.

The processor may promote the node type for the mobile electronic device to be a member node type or a master node type upon detecting a heartbeat signal of another device. The master node type may define a cluster in the network. The member node type may define a member of the cluster.

The processor may promote the node type for the mobile electronic device according to a deterministic rule, such that only one of the mobile electronic device and the other device is promoted to the master node type and only one other of the mobile electronic device and the other device is promoted to the member node type.

When the mobile electronic device is the master node type, the processor may broadcast a heartbeat signal indicating any devices that are members of the cluster as managed by the mobile electronic device.

The plurality of node types may include a conduit node type. When the mobile electronic device is the member node type or the master node type, the processor may promote the node type for the mobile electronic device to be the conduit node type in response to detecting a heartbeat signal from another cluster.

When the mobile electronic device is the conduit node type, the processor may set an inter-cluster connectivity strength for the mobile electronic device based on a former node type for the mobile electronic device.

The plurality of node types may include a conduit node type. When the mobile electronic device is the member node type, the processor may promote the node type for the mobile electronic device to be the conduit node type in response to detecting network traffic of another cluster.

The processor may associate the mobile electronic device as a conduit node type with a plurality of other clusters in response to detecting heartbeat signals from the plurality of other clusters.

The processor may initiate testing of the discrete quantum of data against malware signatures and may cancel transmission of the discrete quantum of data to the identified address when a match to a malware signature is determined.

The processor may initiate evaluation of a request to transmit the discrete quantum of data against a denial of service attack criterion and may cancel transmission of the discrete quantum of data to the identified address when the denial of service attack criterion is met.

According to another aspect of the invention, an integrated circuit is to execute instructions to identify an address of a destination mobile electronic device to be transmitted a discrete quantum of data. The address conforms to an address space defined for a plurality of mobile electronic devices including the destination mobile electronic device. The address space includes a network address of a given mobile electronic device of the plurality of mobile electronic devices and a spatial address indicative of a geographic location of the given mobile electronic device. The instructions further initiate transmission of the discrete quantum of data to the identified address.

The instructions may be contained in an operating system kernel.

The operating system kernel may be separate and independent to an operating system kernel of a mobile electronic device to which the integrated circuit is provided.

### DETAILED DESCRIPTION

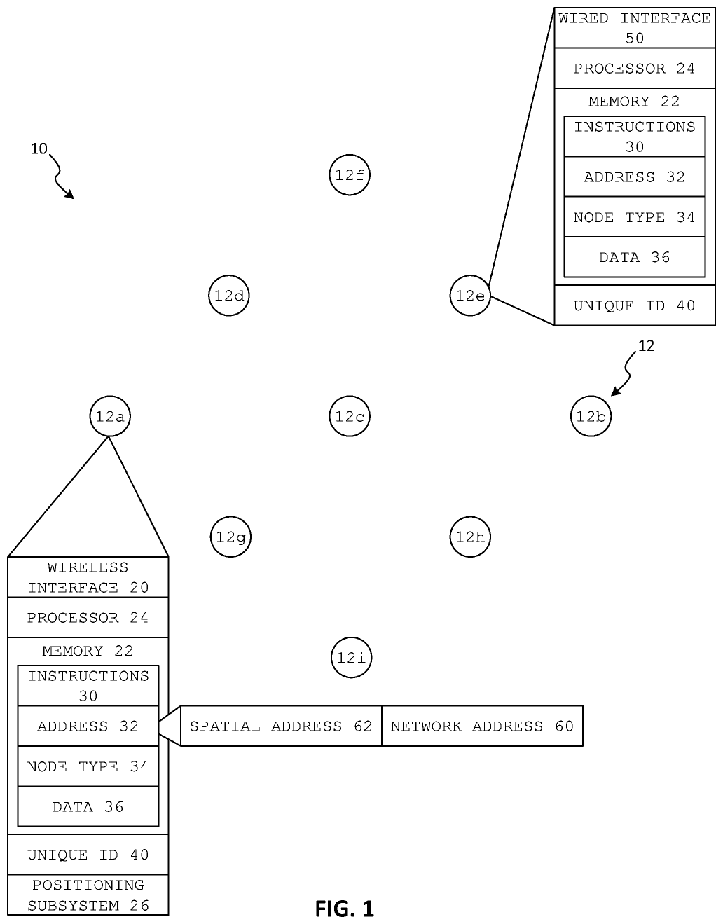

FIG. 1 shows an example communications system 10. The system 10 includes a plurality of nodes 12. Any number of nodes 12 may exist in the system 10 at any given time, as nodes 12 join and leave the system 10. Any particular node or nodes may be generally referred to as node 12. Specific example nodes may be referred to as nodes 12a-12i.

Each node 12 may include an electronic device. Examples of electronic devices include computers, wireless mobile electronic devices, Internet-of-Things (IoT) devices, and similar. Examples of computers include notebook computers, desktop computers, servers, and similar. Examples of wireless mobile electronic devices include smartphones, tablet computers, vehicle computers (e.g., vehicles with drivers, driverless vehicles, drones, etc.), and similar. Examples of IoT devices include thermostats, cameras, alarm devices, appliances, light fixtures, audio devices, video devices, and similar. Further, a node 12 may be configured to operate with other node(s) 12 according to a predetermined operational scheme such as encryption, blockchain, distributed ledger, and similar. These lists are not exhaustive and there may be overlap between categories of electronic devices.

A node 12 may include a wireless communications interface 20, memory 22, a processor 24, and a positioning subsystem 26. The processor 24 may be connected to the wireless communications interface 20, the memory 22, and the positioning subsystem 26 to control operations of the node 12. An example of such a node is node 12a. Nodes 12 that include a wireless communications interface 20 may be mobile or at least may not require a wired connection for communications. Examples of nodes 12 include devices such as smartphones, tablet computers, devices having subscriber identity modules (SIM, embedded SIM or eSIM), network infrastructure, relays, repeaters, switches, security devices, firewalls, servers, and similar. A device may operate as a node 12 even when not being actively used by a user. For example, a user's smartphone may carry out its functionality as a node 12 when locked, idle, or otherwise not in active use.

The wireless communications interface 20 allows the node to communicate wirelessly with other nodes 12 that also have a wireless communications interface 20. Any number of different wireless communications interfaces 20 may be provided for different communications technologies. Examples of wireless communications interfaces 20 include those operable under technologies such as Institute of Electrical and Electronics Engineers (IEEE) 802.11 or Wi-Fi, Bluetooth, Bluetooth Low Energy (BLE), Long-Term Evolution (LTE), Worldwide Interoperability for Microwave Access (WiMAX), fourth generation (4G) standards/technologies, new radio (NR) access technology, fifth generation (5G) standards/technologies, Evolved High Speed Packet Access (HSPA+), Universal Mobile Telecommunications System (UMTS), second-generation/third-generation (2G/3G) General Packet Radio Service (GPRS), and similar technologies. The wireless communications interface 20 may include a SIM, eSIM, or similar.

The memory 22 may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, and the like. The machine-readable storage medium may be encoded with executable instructions. The memory 22 may include volatile memory, non-volatile memory, or both.

The processor 24 may include a central processing unit (CPU), a microcontroller, a microprocessor, a processing core, a field-programmable gate array (FPGA), an application-specific integrated circuit (ASIC), or similar device capable of executing instructions. The processor 24 may cooperate with the memory 22 to execute instructions contained in the memory 22.

The memory 22 may store instructions 30, an address 32, a node type 34, and data 36. Instructions 30 may be executable by the processor 24 to realize functionality described herein, including associating with other nodes 12 using node types 34 and routing and communicating data with other nodes 12 using addresses 32. Data 36 may be user data belonging to a user of the node 12.

The positioning subsystem 26 may include a global positioning system (GPS) receiver, an inertial navigation device, an accelerometer, or similar. The positioning subsystem 26 provides a geographic location of the node 20 to the processor 24. When the node moves, the geographic location may be updated. For nodes 12 that are not mobile or that are not often moved, the positioning subsystem 26 may be a programmable area of memory 22 that stores a geographic location.

A node 12 may further include a unique hardware identifier 40 that uniquely distinguishes the node 12 from other nodes 12. Examples of unique hardware identifiers include a media access control (MAC) address, an International Mobile Subscriber Identity (IMSI), a Mobile Equipment Identifier (MEID), a Mobile Station International Subscriber Directory Number (MSISDN), an International Mobile Equipment Identity (IMEI), a telephone number, or similar. Another example of a unique hardware identifier is a derived value computed from characteristics of hardware and/or software present at the node 12.

A node 12 may include a wired communications interface 50, memory 22, and a processor 24. The processor 24 may be connected to the wired communications interface 50 and the memory 22 to control operations of the node 12. An example of such a node is node 12e. Nodes 12 that include a wired communications interface 20 may be stationary and may be incapable of wireless communications. Examples of such nodes include a server that lacks a dynamic positioning subsystem.

A node 12 may include both a wireless communications interface 20 and a wired communications interface 50.

Various nodes 12, such as nodes 12a, 12e, may accord with this disclosure and may thus include instructions 30, an address 32, and a node type 34. Other nodes 12 may be legacy nodes that are conventional and such nodes may lack instructions 30, an address 32, and a node type 34.

To communicate data with other nodes 12, the processor 24 of a source node 12 identifies an address 32 of a destination node 12 to be transmitted a discrete quantum of data 36 from the memory 22 of the source node 12 via its communications interface 20, 50. The processor 24 then initiates transmission of the discrete quantum of data 36 to the identified address 32 of the destination node 12 by communicating such data 36 to a known connected node 12 along a data path to the destination node 12.

The address 32 conforms to an address space defined for all of the nodes 12 whether such a node stores its address 32 and is aware of the address space or is a legacy node that may be upgraded later. The address space includes a network address 60 and a spatial address 62. The network address 60 may be an Internet Protocol version 4 (IPV4), IPV6 address, or similar. The spatial address 62 is indicative of a geographic location of the node 12. The spatial address 62 component of the address space may store a geographic location of a node 12 as determined by a positioning subsystem 26, if present at the node 12. The spatial address 62 may be expressed as coordinates. The address space may have a length, for example, of 64 to 128 bits. The address space may be telescopic in that the length of spatial address 62 component may be extended, so as to accommodate additional locations or greater location resolution. The address space may be expanded as new communications technologies are implemented, particularly when a new communications technology defines a new type of network address.

A node 12 that has a positioning subsystem 26 may continually update its address 32 based on its measured geographic position.

The nodes 12 may be configured to associate with nearby nodes 12 into organizational units or clusters. Each node 12 may be limited to belong to a single cluster at any given time. Nearby nodes 12 may include nodes 12 that are within range of a broadcasted heartbeat signal.

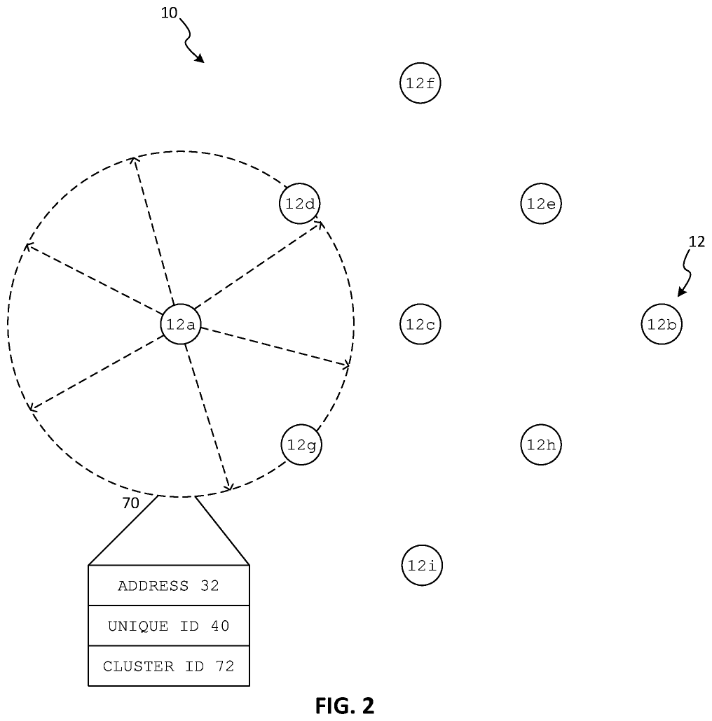

With reference to FIG. 2, to create an association or cluster of nodes 12, the processor 24 of a given node 12 may generate a heartbeat signal 70 and may broadcast the heartbeat signal 70 via its communications interface 20, 50. The heartbeat signal 70 may indicate the address 32 of the broadcasting node 12. The heartbeat signal 70 may further indicate the unique hardware identifier 40 of the broadcasting node 12. The heartbeat signal 70 may further indicate a cluster identifier 72 of the cluster to which the broadcasting node 12 belongs, if any. An example heartbeat signal 70 is a 64-bit User Datagram Protocol (UDP) message that is periodically broadcasted, such as every 1 second. In various example implementations, only nodes 12 that are isolated or that are of a master node type, described below, generate and broadcast heartbeat signals 70.

Nodes 12 that detect a heartbeat signal 70 via their communications interfaces 20, 50 may associate with the broadcasting node 12 to form a cluster. A cluster of nodes 12 is the fundamental organizational unit of the communications system 10. All nodes 12 may be configured to listen for heartbeat signals and network traffic regardless of source, such as traffic communicated as described herein, IPV4 traffic, IPV6 traffic, and similar.

The role of each node 12 within its cluster is determined by its node type 34. Node type 34 is selected from a plurality of preset node types. A given node 12 may only have one node type 34 at one time. Nodes 12 may be configured to self-promote and self-demote their node types based on the rules discussed herein.

Example node types 34 include an isolated node type, a master node type, a member node type, and a conduit node type. Each cluster has one master node that maintains organization of the cluster. Each cluster may have any number of member nodes. Each cluster may have any number of conduit nodes, which provide data conduits to other clusters. Nodes in a cluster may be directly aware of other nodes in the cluster, via detection of a heartbeat signal issued by the master node of the cluster, or may infer the existence of other nodes in the cluster via a manifest or list of nodes that is maintained by any number of nodes in the cluster. The master node has the authoritative list of nodes of its cluster. The node types and transitions among these node types are described in detail below.

In various examples, master nodes issue heartbeat signals to facilitate the growth of clusters and form conduits between clusters. Member nodes may remain silent unless they have communications to make, respond to, or acknowledge.

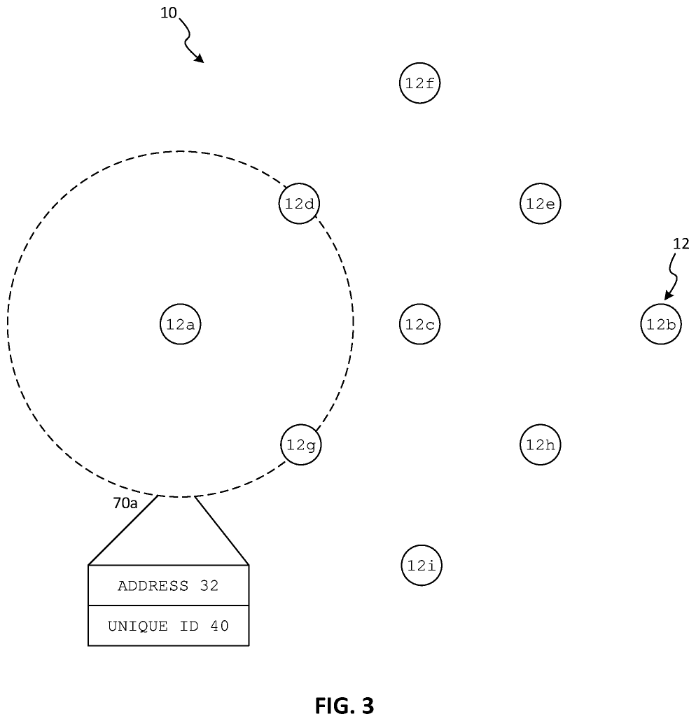

With reference to the example shown in FIG. 3, node 12a may be of an isolated node type. That is, node 12a does not belong to a cluster of nodes 12. An isolated node 12a broadcasts a heartbeat signal 70a indicating at least its address 32. Isolated nodes 12 listen via their communications interfaces 20, 50 for heartbeat signals broadcasted by other nodes 12. In the example shown, nodes 12d and 12g are isolated nodes that detect the heartbeat signal 70a of node 12a.

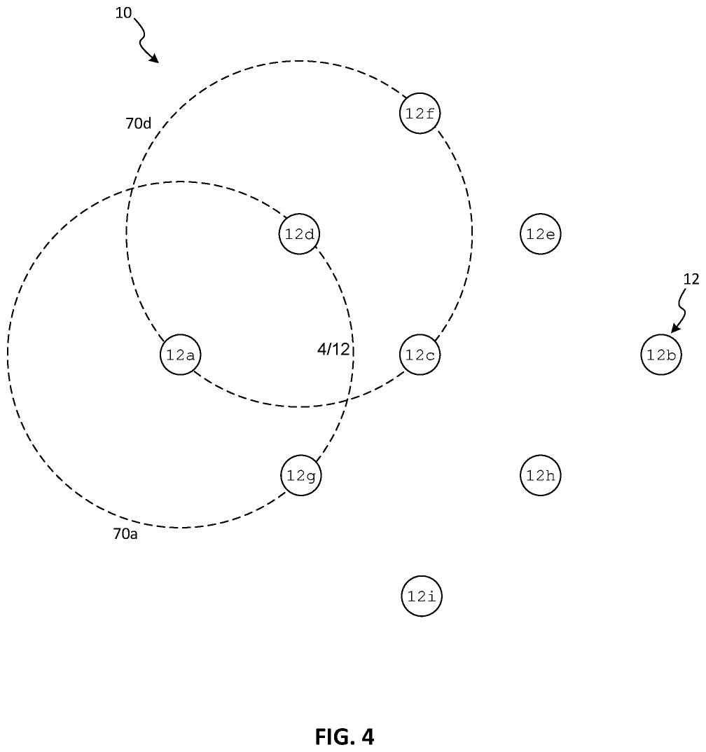

As shown in the example of FIG. 4, the isolated node 12d detects the heartbeat signal 70a of isolated node 12a, and isolated node 12a detects the heartbeat signal 70d of isolated node 12d. When isolated nodes are in mutual communication of their heartbeat signals, then one of the isolated nodes becomes a master node and the other isolated node(s) becomes a member node(s) of the cluster defined by the newly determined master node.

Each isolated node 12 may promote itself to a master node type or a member node type of the newly formed cluster. A deterministic rule may be used, such that only one of the isolated nodes becomes the master node type and the other isolated node(s) takes the member node type. Such a deterministic rule may eliminate the need for communication to negotiate which nodes will take which node types. An example deterministic rule is the isolated node 12 with the larger unique hardware identifier 40, when taken as a numerical value, becomes the master node type with all other nodes becoming member nodes.

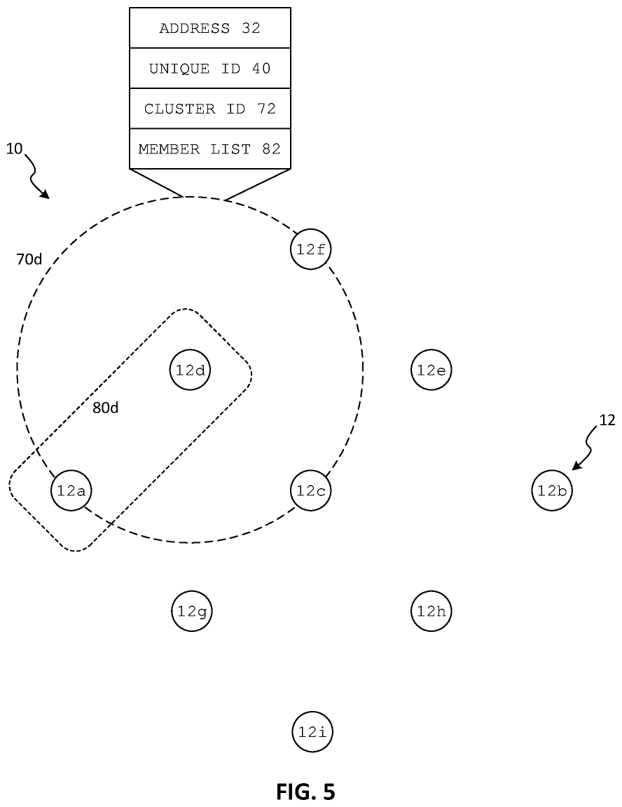

As shown in the example of FIG. 5, node 12d has become the master node and node 12a has become the member node of a newly formed cluster 80d. Master node 12d includes in its heartbeat signal 70d a list 82 of member nodes indicating any nodes that are members of its cluster 80d. As such, each member node 12a of the cluster 80d is aware of each other node in the cluster 80d.

If a member node 12a fails to detect the heartbeat signal 70d of its cluster 80d, the member mode 12a becomes an isolated node. This may be indicative of one or both of the nodes 12a, 12d having moved.

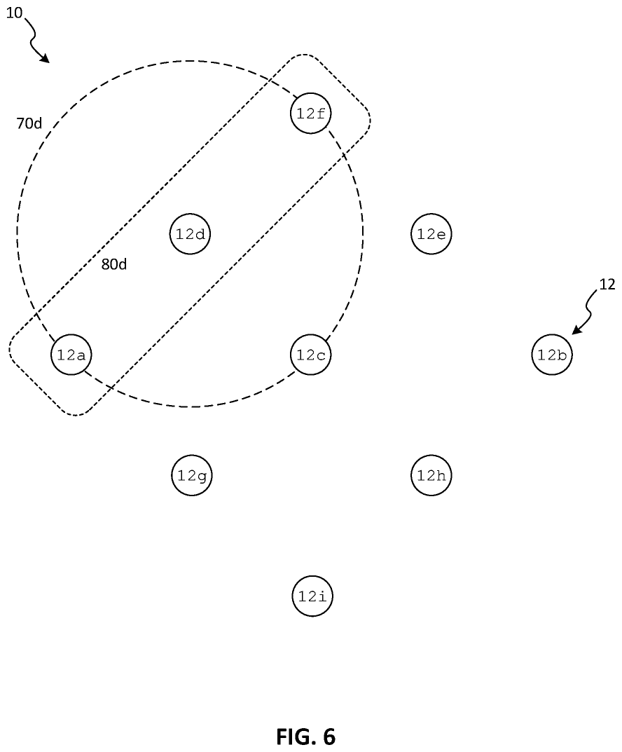

If an isolated node 12f detects the heartbeat signal 70d of a cluster 80d, the isolated node 12f may join the cluster 80d, as shown in FIG. 6.

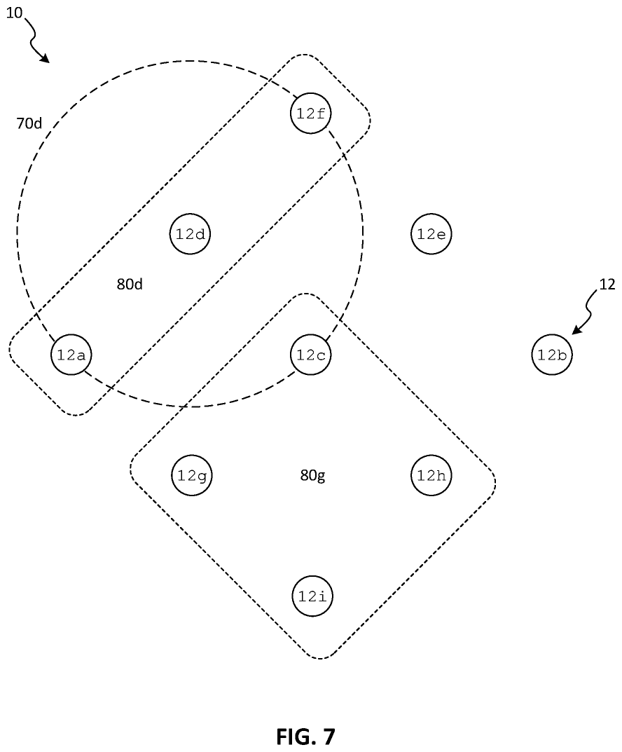

In the example shown in FIG. 7, two clusters 80d, 80g have formed, as described above, with respective master nodes 12d, 12g.

If a member node 12c of a cluster 80g detects a heartbeat signal from a master node of another cluster 80d then, in response, the member node 12c promotes itself to the conduit node type. Likewise, if a master node 12d of a cluster 80g detects a heartbeat signal from a master node of another cluster 80d then, in response, the master node 12d promotes itself to the conduit node type.

Conduit nodes may maintain their original member/master roles. The conduit node type may have subtypes to track original member/master roles. Subtypes may also indicate inter-cluster connectivity strength. That is, conduit node subtypes may indicate the strength of a data path with a neighboring cluster.

Conduit node subtypes may be defined for unique combinations of node types of the nodes associated with the promotion of a given node to the conduit node type. That is, a conduit node may take a conduit node subtype based on its original node type and based on the node type of a source of the heartbeat signal from the other cluster.

Conduit node subtypes may be defined for the following combinations:

1. Conduit node is a member of its cluster that can detect traffic from a different cluster but cannot detect the heartbeat signal of the master node of the different cluster (weak conduit);

2. Conduit node is a member node of its cluster and can detect the heartbeat signal of master node of a different cluster (stronger conduit); and

3. Conduit node is the master node of its cluster and can detect the heartbeat signal of master node of a different cluster (strongest conduit).

It should be noted that a conduit node still belongs to one cluster, for example, the cluster that it originally joined.

Regarding inter-cluster connectivity strength, the first combination above may be considered the weakest subtype, the second combination above may be considered a stronger subtype, and the third combination above may be considered the strongest subtype.

From the perspective of the cluster to which a conduit node belongs, the weakest conduit node subtype represents a node that can route data to a node of a neighboring cluster. This may be considered weak or may be relatively unreliable, as member nodes may readily leave and join clusters. As such, the conduit may be lost if the member node of the other cluster leaves that cluster. The stronger conduit node subtype represents a member node that can route data to a master node of a neighboring cluster. This may be considered more reliable, as a master node cannot leave its cluster until all its member nodes leave. The strongest conduit node subtype represents a master node that can route data to a master node of a neighboring cluster. This may be considered the strongest or most reliable connection, as both nodes node cannot leave their clusters until all respective member nodes leave.

After promotion to a conduit node type, a node may retain its prior functionality and this may be indicated by the subtype.

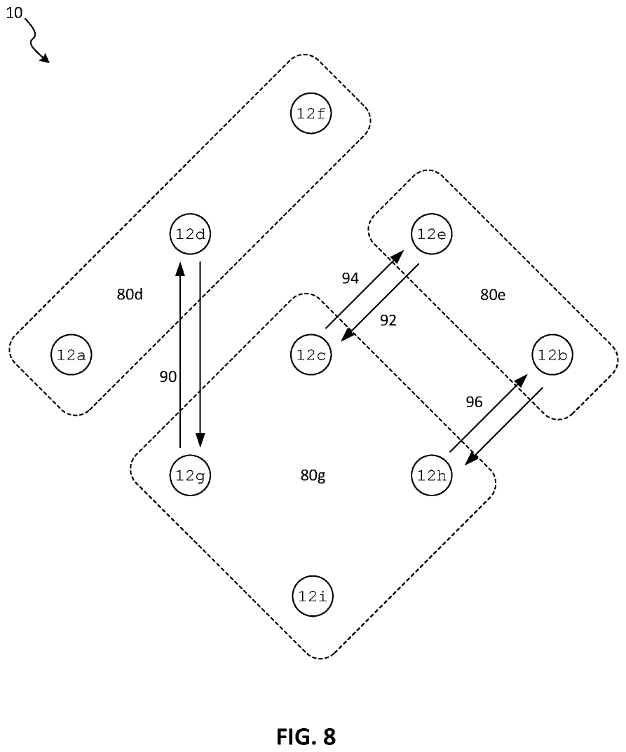

FIG. 8 shows example conduit nodes 12b, 12c, 12d, 12e, 12g, 12h. Conduit nodes 12c, 12h are member nodes of a cluster 80g. Conduit node 12g is the master node of the cluster 12g. Conduit node 12d is the master node of a cluster 80d. Conduit node 12e is the master node of a cluster 80e. Conduit node 12b is a member node of the cluster 80e. As such, the bidirectional conduit strength 90 between nodes 12d, 12g may be considered strongest, as both nodes 12d, 12g are masters of their respective clusters 80d, 80g. The conduit strength 92 from cluster 80e to cluster 80g may be considered weak, as the destination node 12c is a member node. On the other hand, the conduit strength 94 from cluster 80g to cluster 80e may be considered strong, as the destination node 12e is a master node. The bidirectional conduit strength 96 between nodes 12b, 12h may be considered weakest, as both nodes 12b, 12h are member nodes of their respective clusters 80e, 80g.

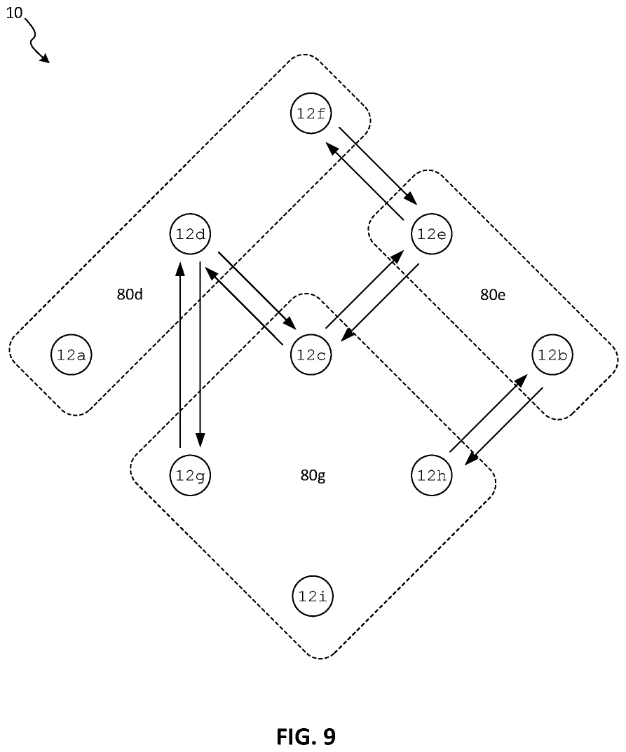

As shown in FIG. 9, conduit nodes may establish one-to-one, many-to-one or one-to-many, and many-to-many connectivity relationships among clusters. That is, any two clusters may be connected by one or more data paths through any number of conduit nodes. Any given conduit node may provide one or more conduits for data to any cluster, in response to detecting a heartbeat signal from that cluster. In the example depicted, clusters 80d, 80g have a one-to-many/many-to-one relationship and one node 12d of the cluster 80d connects to many nodes 12c, 12g of the cluster 80g. Clusters 80d, 80e have a one-to-one relationship with one node 12f, 12e from each cluster 80d, 80e being in communication. Clusters 80e, 80g have a many-to-many relationship.

Accordingly, the subtype of a conduit node may be unique for each connected node. That is, a given conduit node may provide a strong connection to one cluster and a weak connection to another cluster.

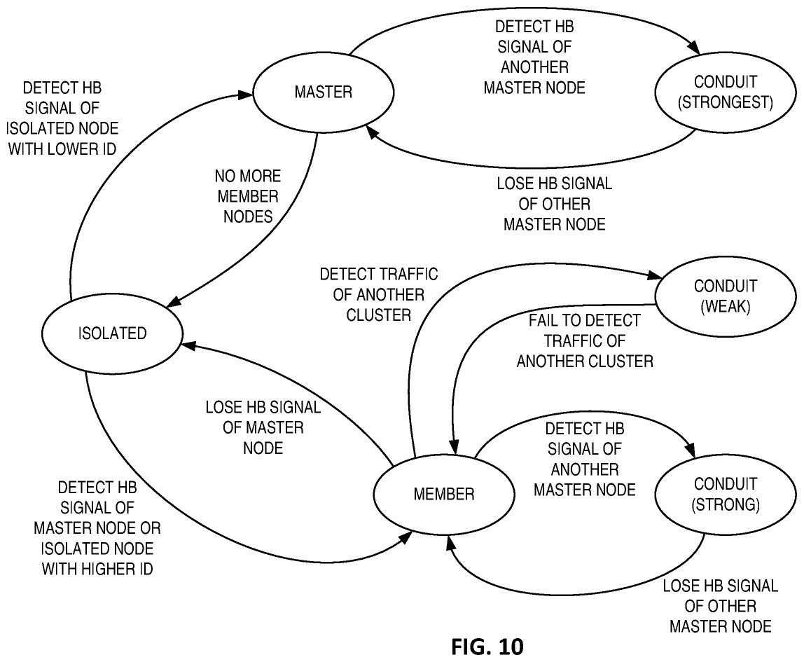

Nodes 12 may be configured to self-promote and self-demote their node types and subtypes. FIG. 10 shows a state diagram of node types/subtypes. Transitions between states are triggered by the detection or failure to detect a given heartbeat (HB) signal or network traffic. For example, a member node promotes itself to a strong conduit node if it detects a heartbeat signal of a master of another cluster (i.e., it detects its own master's heartbeat signal as well as a heartbeat signal from another cluster). The strong conduit node demotes itself back to a regular member node if it fails to detect the heartbeat signal of the master of the other cluster. Similarly, a master node promotes/demote itself to/from the strongest conduit type based on detection (or not) of a heartbeat signal of another cluster. Likewise, a member node promotes/demote itself to/from the weak conduit type based on detection (or not) of traffic of another cluster Detection of a heartbeat signal or traffic and loss thereof may be time based. That is, a threshold time may be referenced when determining whether a signal or traffic is not detected and a node should demote itself.

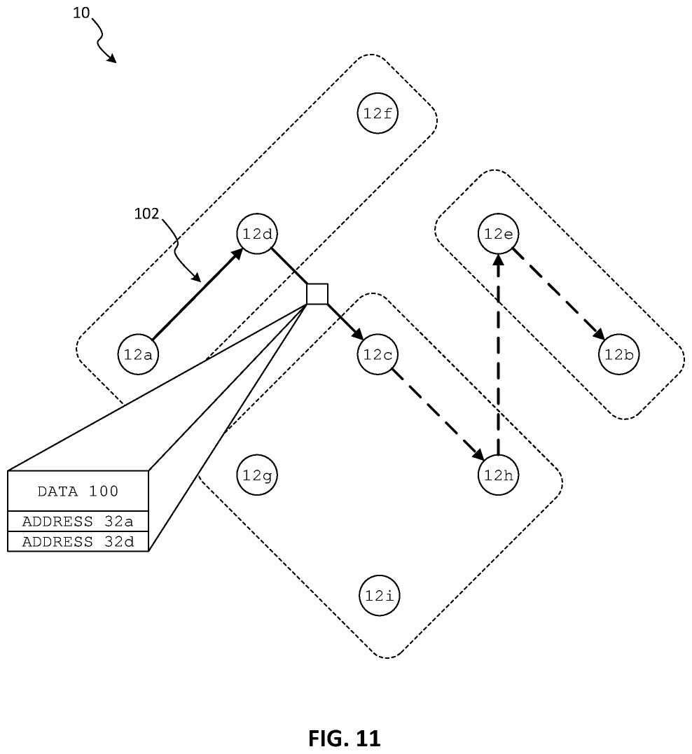

As shown in FIG. 11, a node may communicate data with reference to the known addresses of nodes within the same cluster and with reference to conduit nodes within the same cluster, where destination clusters of such conduit nodes may be tracked in the list of nodes of the cluster.

For example, a discrete quantum 100 of data, such as a packet, may be communicated from node 12a to node 12b via a path 102 through nodes 12d, 12c, 12h. The path may extend between and/or within clusters and may be constructed based on the information held by each cluster, as to its member nodes and its conduits to other clusters. The path 102 may be built based on reducing or minimizing time of delivery or latency, rather than by minimizing or reducing number of hops. To facilitate construction of the path 102 and a return path (which may be the same path 102 or a different path), each node 12 may append its address to a routing log included with the discrete quantum 100 of data. In the example show, nodes 12a, 12d have appended their respective addresses 32a, 32d to the quantum 100 of data. Subsequent legs of the path 102 to destination node 12b may have yet to be defined.

Construction of the path may reference the addresses 32 of the nodes 12. Legacy nodes lack a spatial address 62 component and may be considered based on network address 60. Nodes that accord with this disclosure and include a spatial address 62 component be considered based on the full address 32. Routing to a geographically nearby node that may be several or many network hops away may reduce total latency.

Any of the nodes 12 along the path 102 may be configured to initiate testing of the discrete quantum 100 of data against malware signatures. If the quantum 100 of data matches a malware signature, then the node 12 that detected such cancels transmission of the discrete quantum 100 of data. As such, the proliferation malware may be blocked and the effectiveness of the blocking may be proportional to the number of nodes 12 that are configured to test for malware. If all nodes 12 are so configured, then a quantum 100 of data that contains malware may be blocked from leaving its source node.

Any of the nodes 12 may be configured to store malware signatures and test data against malware signatures. Storage and testing of malware signatures may be concentrated at relatively few nodes 12.

Any of the nodes 12 along the path 102 may be configured to initiate evaluation of a request to transmit the discrete quantum 100 of data against a denial of service attack criterion. If the denial of service (DoS) attack criterion is met, then the node 12 may cancel transmission of the discrete quantum 100 of data. An example denial of service attack criterion may specify an acceptable data rate to a particular destination node. In some examples, all nodes 12 are configured to initiate evaluation of data against the denial of service attack criterion

Any of the nodes 12 may be configured to evaluate the denial of service attack criterion.

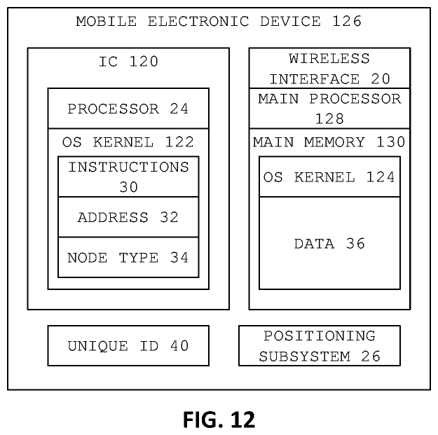

FIG. 12 shows an integrated circuit 120 configured with the above-described functionality. The integrated circuit 120 may be an ASIC. The instructions 30, address 32, and node type 34 may be contained in an operating system kernel 122 that is separate and independent to an operating system kernel 124 of a mobile electronic device 126 to which the integrated circuit 120 is provided. The mobile electronic device 126 may include a main processor 128 and memory 130 for performing user operations on user data 36 stored in the memory 130. The integrated circuit 120 may be used to communicate data 36 via the wireless interface 20. The mobile electronic device 126 may be a smartphone to which the integrated circuit 120 is added.

The techniques described herein are scalable to various sizes of network and can account for changing network topology as well as highly mobile nodes. Both wired and wireless devices may be included. Legacy devices may be included, as the address space described herein subsumes a legacy network address. Communications latency may be reduced by routing using the address space described herein, as geographic location may indicate low latency while number of hops may not. Denial of service attacks and malware proliferation may be stopped close to source rather than close to destination, which may help reduce unnecessary or unwanted traffic. The techniques described herein may be implemented at a network layer.

It should be recognized that features and aspects of the various examples provided above can be combined into further examples that also fall within the scope of the present disclosure. In addition, the figures are not to scale and may have size and shape exaggerated for illustrative purposes.

1. A mobile electronic device comprising:
a wireless communications interface to communicate data;
memory; and
a processor connected to the wireless communications interface and the memory, the processor to identify an address of a destination mobile electronic device to be transmitted a discrete quantum of data from the memory via the wireless communications interface, the address conforming to an address space defined for a plurality of devices including the mobile electronic device and the destination mobile electronic device, the address space including a network address of a given device of the plurality of devices and a spatial address indicative of a geographic location of the given device, the processor further to initiate transmission of the discrete quantum of data to the identified address.

2. The mobile electronic device of claim 1, further comprising a positioning subsystem to determine a geographic location of the mobile electronic device, wherein the memory is to maintain an address of the mobile electronic device including a spatial address corresponding to the geographic location of the mobile electronic device as determined by the positioning subsystem.

3. The mobile electronic device of claim 2, wherein the processor is to generate a heartbeat signal and to broadcast the heartbeat signal via the wireless communications interface, the heartbeat signal indicating the address of the mobile electronic device.

4. The mobile electronic device of claim 3, wherein the heartbeat signal further indicates a unique hardware identifier of the mobile electronic device.

5. The mobile electronic device of claim 2, wherein the processor is to append the address of the mobile electronic device to a routing log included with the discrete quantum of data.

6. The mobile electronic device of claim 2, wherein the memory is to maintain an indication of node type for the mobile electronic device within a network associated with the address space, the node type selected from a plurality of node types.

7. The mobile electronic device of claim 6, wherein the plurality of node types includes an isolated node type, wherein, when the mobile electronic device is the isolated node type, the processor is to broadcast a heartbeat signal indicating the address of the mobile electronic device and is to listen via the wireless communications interface for heartbeat signals broadcasted by other devices.

8. The mobile electronic device of claim 7, wherein the processor is to promote the node type for the mobile electronic device to be a member node type or a master node type upon detecting a heartbeat signal of another device, the master node type defining a cluster in the network, the member node type defining a member of the cluster.

9. The mobile electronic device of claim 8, wherein the processor is to promote the node type for the mobile electronic device according to a deterministic rule, such that only one of the mobile electronic device and the other device is promoted to the master node type and only one other of the mobile electronic device and the other device is promoted to the member node type.

10. The mobile electronic device of claim 8, wherein when the mobile electronic device is the master node type, the processor is to broadcast a heartbeat signal indicating any devices that are members of the cluster as managed by the mobile electronic device.

11. The mobile electronic device of claim 8, wherein the plurality of node types includes a conduit node type, wherein, when the mobile electronic device is the member node type or the master node type, the processor is to promote the node type for the mobile electronic device to be the conduit node type in response to detecting a heartbeat signal from another cluster.

12. The mobile electronic device of claim 11, wherein when the mobile electronic device is the conduit node type, the processor is to set an inter-cluster connectivity strength for the mobile electronic device based on a former node type for the mobile electronic device.

13. The mobile electronic device of claim 12, wherein the plurality of node types includes a conduit node type, wherein, when the mobile electronic device is the member node type, the processor is to promote the node type for the mobile electronic device to be the conduit node type in response to detecting network traffic of another cluster.

14. The mobile electronic device of claim 11, wherein the processor is to associate the mobile electronic device as a conduit node type with a plurality of other clusters in response to detecting heartbeat signals from the plurality of other clusters.

15. The mobile electronic device of claim 1, wherein the processor is to initiate testing of the discrete quantum of data against malware signatures and is to cancel transmission of the discrete quantum of data to the identified address when a match to a malware signature is determined.

16. The mobile electronic device of claim 1, wherein the processor is to initiate evaluation of a request to transmit the discrete quantum of data against a denial of service attack criterion and is to cancel transmission of the discrete quantum of data to the identified address when the denial of service attack criterion is met.

17. An integrated circuit to execute instructions to identify an address of a destination mobile electronic device to be transmitted a discrete quantum of data, the address conforming to an address space defined for a plurality of mobile electronic devices including the destination mobile electronic device, the address space including a network address of a given mobile electronic device of the plurality of mobile electronic devices and a spatial address indicative of a geographic location of the given mobile electronic device, the instructions further to initiate transmission of the discrete quantum of data to the identified address.

18. The integrated circuit of claim 17, wherein the instructions are contained in an operating system kernel.

19. The integrated circuit of claim 18, wherein the operating system kernel is separate and independent to an operating system kernel of a mobile electronic device to which the integrated circuit is provided.
